(19) United States
(12) Patent Application Publication
(10) Pub. No.: US 2023/0095430 A1
(43) Pub. Date: Mar. 30, 2023

(54) CHARGING OF ELECTRIC VEHICLES AND CONSTRUCTION MACHINES

(71) Applicant: Perkins Engines Company Limited, Peterborough (GB)

(72) Inventor: Thomas TWIGGER, Spalding (GB)

(73) Assignee: Perkins Engines Company Limited, Peterborough (GB)

(21) Appl. No.: 17/911,453

(22) PCT Filed: Mar. 9, 2021
(86) PCT No.: PCT/EP2021/025096

§ 371 Date: Sep. 14, 2022

(30) Foreign Application Priority Data
Mar. 20, 2020 (GB) 2004101.8

(51) Int. Cl. B60L 53/62; H02J 7/00; B60L 58/16; H01M 10/633; H01M 10/44

(52) U.S. Cl. CPC B60L 53/62; H02J 7/0048; H02J 7/00032; H02J 7/00712; H02J 7/005; B60L 58/16; H01M 10/633; H01M 10/443; B60L 2200/40; B60L 2240/545; E02F 9/2091

(57) ABSTRACT

A method for managing state of charge of a battery of an electric work vehicle to be ready to return to work at a return to work time that coincides with an end of a duration of immobilization. A charge mode is selected via a user interface. An initial state of charge of the battery and a target operational state of charge of the battery are used to calculate a targeted charge increase. A charge cycle comprising a charge rate is selected based on the charge mode and the targeted charge increase. A charging start time is calculated such that at the return to work time an actual state of charge of the battery corresponds to the target operational state of charge. The temperature of the battery is adjusted to be a target temperature at the charging start time. The charge cycle is started at the charging start time.

### FIELD OF THE DISCLOSURE

The disclosure relates to the field of charging electric vehicles or construction machines.

### BACKGROUND

An electric vehicle or construction machine may comprise a storage battery inside the electric vehicle that is charged with power using an external vehicle charging apparatus. Conventionally, many electric vehicles default to a fast charge scenario, assuming that the operator wants the vehicle to be ready for use as soon as possible. The battery is then held at a high state of charge until it is used.

The health of a storage battery depends on several factors, including the rate at which the battery is charged, the state of charge at which the battery is stored and the temperature of the battery during charging. Fast charging can increase battery ageing, for example due to thermal shock. Many batteries can only undergo a limited number of fast charge cycles before performance degradation occurs to an extent that limits the battery capacity to below an acceptable value. Storing a battery at high state of charge also increases battery ageing.

It is known to provide functionality for a user to choose a charging mode based on information about the cost of electricity (U.S. Pat. No. 8,716,978 B2). The lowest cost of power may be determined on the basis of a predetermined time period for charging, and the user can choose whether to proceed with fast charging or to wait to charge the vehicle at the charging period with the lowest cost.

It is known to provide a charging management system that stores the battery at low state of charge and charges just before the electric vehicle is required, rather than charging immediately and storing the battery at a high state of charge (EP 2398670 A1). The duration of immobilization of the vehicle and the time taken for a full charge from the initial state of the battery are used to schedule charging such that the battery remains in a low state of charge for as long as possible in storage, and the battery reaches the highest level of charge just before the vehicle is used.

Storing batteries at low state of charge is important for long-term battery health, however it is may also be preferable to use lower charge rates. Particularly in the case of electric work vehicles with long, known periods of immobilization it may be useful to manage charging such that the storage state of charge is low and the rate of charging is also low. The charge rate can be determined from the length of the period of immobilization.

Small off-highway electrified construction machinery may typically be operational between predicable times. For example, such electric work vehicles might be expected to work a single shift in a day, 5 days a week and be unused overnight and at weekends. They may also be put into long term storage.

### SUMMARY OF THE DISCLOSURE

Against this background, there is provided: a method for managing state of charge of a battery of an electric work vehicle to be ready to return to work at a return to work time that coincides with an end of a duration of immobilization, comprising:
a. selecting a charge mode via an input of a user interface and obtaining data from an output of the user interface indicative of a charge mode;
b. using an initial state of charge value of the battery and a target operational state of charge value of the battery to calculate a targeted charge increase;
c. selecting a charge cycle based on the charge mode and the targeted charge increase, wherein the charge cycle comprises a charge rate;
d. calculating a charging start time based on the charge rate and the targeted charge increase, such that at the return to work time an actual state of charge of the battery corresponds to the target operational state of charge value;
e. using an initial temperature of the battery and a target temperature of the battery to calculate a targeted temperature change;
f. using the targeted temperature change to calculate a heat exchange start time such that the battery is at the target temperature before the charging start time;
g. adjusting the temperature of the battery at the heat exchange start time such that the battery is at the target temperature at the charging start time; and
h. starting the charge cycle at the charging start time such that the battery is at the target operational state of charge at the return to work time.

In this way, it may be possible to manage the charging of an electric work vehicle in such a way that combines considerations of long term battery health with return to work requirements. Scheduling charging in such a way allows the battery to be warmed before charging begins, to prevent thermal shock and prolong battery lifetime. The battery can be stored at a low state of charge and the charge rate can be chosen to be slower when the vehicle is not needed imminently, which slows battery degradation. Other preparation for returning to work may also be carried out. For example, work vehicles often have a hydraulic circuit for operating a work tool. Cold, viscous hydraulic fluid may result in parasitic losses which may reduce charge efficiency. It may be beneficial for the hydraulic fluid to be warmed before the vehicle is ready to return to work, which can be scheduled based on the charging schedule.

In a second aspect there is provided: a battery charging controller for managing state of charge of a battery of an electric work vehicle to be ready to return to work at a return to work time that coincides with an end of a duration of immobilization, the battery charging controller configured to:
a. receive first data comprising an initial state of charge value of the battery;
b. receive second data from a user interface, wherein the second data is indicative of a charge mode;
c. receive third data comprising an initial temperature of the battery;
d. use the first data and a target operational state of charge of the battery to calculate a targeted charge increase;
e. select a charge cycle based on the second data and the targeted charge increase, wherein the charge cycle comprises a charge rate;
f. calculate a charging start time based on the charge rate and the targeted charge increase, such that at the return to work time an actual state of charge of the battery is the target operational state of charge value;
g. use the third data and a target temperature of the battery to calculate a targeted temperature change;
h. use the targeted temperature change to calculate a heat exchange start time such that the battery is at the target temperature before the charging start time;
i. adjust the temperature of the battery at the heat exchange start time such that the battery is at the target temperature at the charging start time; and
j. start the charge cycle at the charging start time such that the battery is at the target operational state of charge at the return to work time.

### BRIEF DESCRIPTION OF THE DRAWINGS

A specific embodiment of the disclosure will now be described, by way of example only, with reference to the accompanying drawings in which:

FIG. 1 shows a process for selecting a charge cycle and managing the state of charge of a battery in accordance with an embodiment of the disclosure.

FIG. 2 shows a process for selecting a charge cycle, managing the state of charge of a battery and warming hydraulic fluid in accordance with an embodiment of the disclosure.

FIG. 3 shows a process for selecting a charge cycle and managing the state of charge of a battery wherein the battery may be stored at a storage state of charge, in accordance with an embodiment of the disclosure.

FIG. 4 shows a process for selecting a charge cycle and managing the state of charge of a battery wherein the battery may be charged in the event that the targeted charge increase is above a threshold, in accordance with an embodiment of the disclosure.

FIG. 5 shows a process for selecting a charge cycle and managing the state of charge of a battery wherein the battery may be stored at a storage state of charge and may be charged in the event that the targeted charge increase is above a threshold, in accordance with an embodiment of the disclosure.

### DETAILED DESCRIPTION

According to an embodiment of this disclosure, there is a method for managing the state of charge of a battery of an electric work vehicle to be ready to return to work at a return to work time that coincides with an end of duration of immobilization. The battery of the electric work vehicle may be connected to an external charging device. A controller may be used to manage the state of charge of the battery.

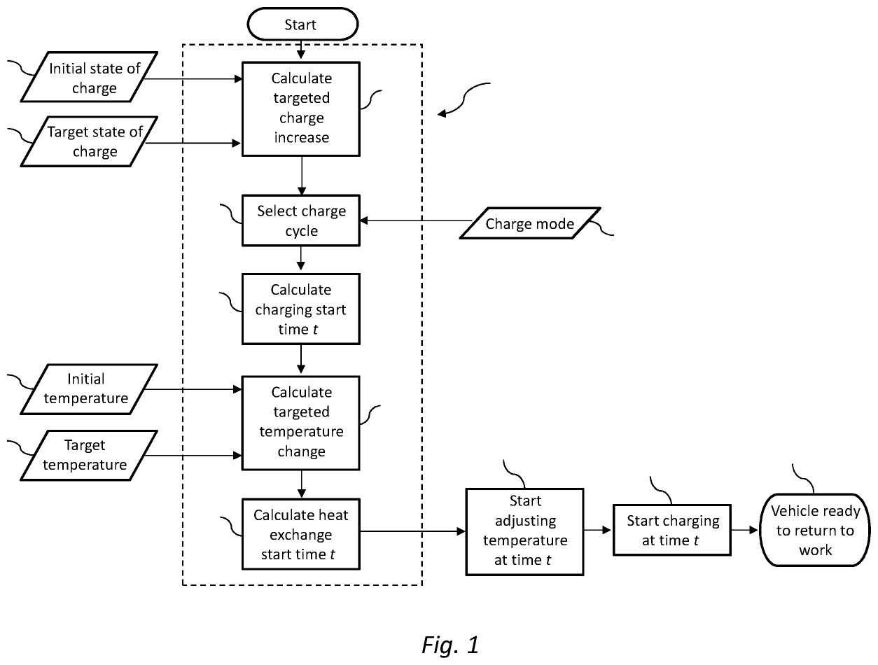

Referring to FIG. 1, various data inputs may be used to determine a charge cycle and calculate the charging schedule. The user may select a charge mode 121 via an input of the user interface. In the event that the charge mode selected is not a long-term storage mode, the charge mode 121 may correspond to a pre-determined duration of immobilization. The steps which may be involved in determining the charge cycle and schedule are shown within the dashed line 100. At step 110 an initial state of charge value 111 for the battery and a target state of charge value 112 are used to calculate a targeted charge increase. The charge mode 121 and the calculated targeted charge increase are used to select a charge cycle at step 120, wherein the charge cycle comprises a charge rate. The charge rate may be chosen such that the time it will take to charge the battery is less than the expected duration of immobilization of the vehicle. The charge rate may be constant or may vary over time. At step 130, the charge rate and targeted charge increase may be used to calculate how long it will take to charge the battery from the initial state of charge value to the targeted state of charge value. The expected duration of immobilization is then used to calculate the start time for charging t_{C} such that the state of charge value of the battery will be equal to the target state of charge value at or before the return to work time. At step 140 an initial temperature of the battery 141 and a target temperature of the battery 142 may be used to calculate a targeted temperature change. The targeted temperature change may be used to calculate how long it will take to cool or heat the battery from the initial temperature to the target temperature 142. The start time for the heat exchange process t_{T} may then be calculated at step 150 such that the battery reaches the target temperature 142 at or before the start time for charging t_{C}. At the heat exchange start time t_{T} the heat exchange process begins (step 160). At the charging start time t_{C} the battery is at the target temperature, and the charging begins at the charge rate associated with the selected charge cycle (step 170). At step 180 the vehicle is then ready to return to work, with a state of charge value equal to the target state of charge value 112, at the end of the expected duration of immobilization.

The user interface provides at least one selectable charge mode 121, wherein the charge mode 121 may correspond to a duration of immobilization of the work vehicle. In an embodiment, the user may choose from a pre-determined list of selectable charge modes 121, for example fast charge, regular charge, overnight, weekend or long-term storage. In a certain embodiment, the overnight mode might correspond to a duration of immobilization of, for example, 12 hours and the weekend mode might correspond to a duration of immobilization of, for example, 60 hours.

The charge cycle is selected at step 120 based on the targeted charge increase and the expected duration of immobilization. The charge cycle may be selected from a pre-programmed list of charge cycles. In an embodiment, the pre-programmed list of charge cycles may comprise one or more charge cycles for each selectable charge mode 121. The one or more charge cycles for each selectable charge mode 121 may comprise different charge rates. In an embodiment, the charge rate may be chosen to be slower than a charge rate used for fast charging. In a certain embodiment, the charge cycle may be selected to have the slowest charge rate for which it is still possible to charge the battery to have a state of charge value equal to the target state of charge value at the return to work time at the end of the duration of immobilization.

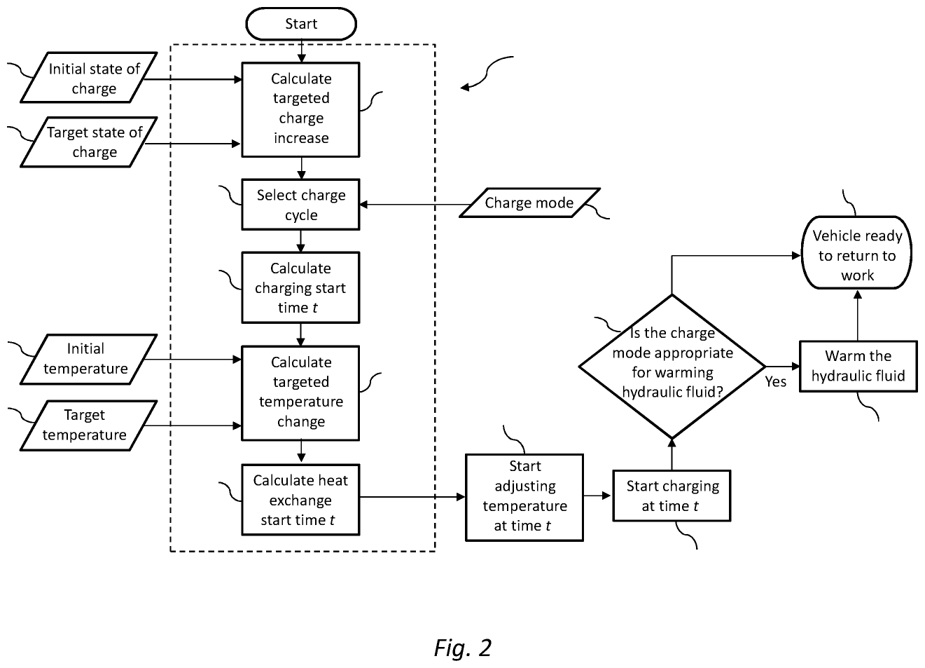

Referring to the embodiment described in FIG. 2, there may be an additional step 220 of warming hydraulic fluid. Work vehicles may comprise a hydraulic circuit for effecting movement of a machine work tool. Viscous hydraulic fluid results in parasitic power losses so warming the hydraulic fluid to reduce its viscosity prior to the vehicle returning to work increases charge efficiency. The warming of the hydraulic fluid may be carried out such that the hydraulic fluid is at target operational temperature at the return to work time of the vehicle. In an embodiment of the disclosure, the warming of the hydraulic fluid may take place during charging of the battery using power from the external charging device. In an embodiment, the warming of the hydraulic fluid may take place in the event that certain charge modes 121 are selected that are appropriate for warming the hydraulic fluid. A charge mode 121 that would be appropriate for warming hydraulic fluid would correspond to a duration of immobilization and so would be indicative of a return to work time, for example fast, overnight or weekend modes. In the event that the charge mode 121 is appropriate for warming the hydraulic fluid at step 210, the hydraulic fluid is warmed at step 220.

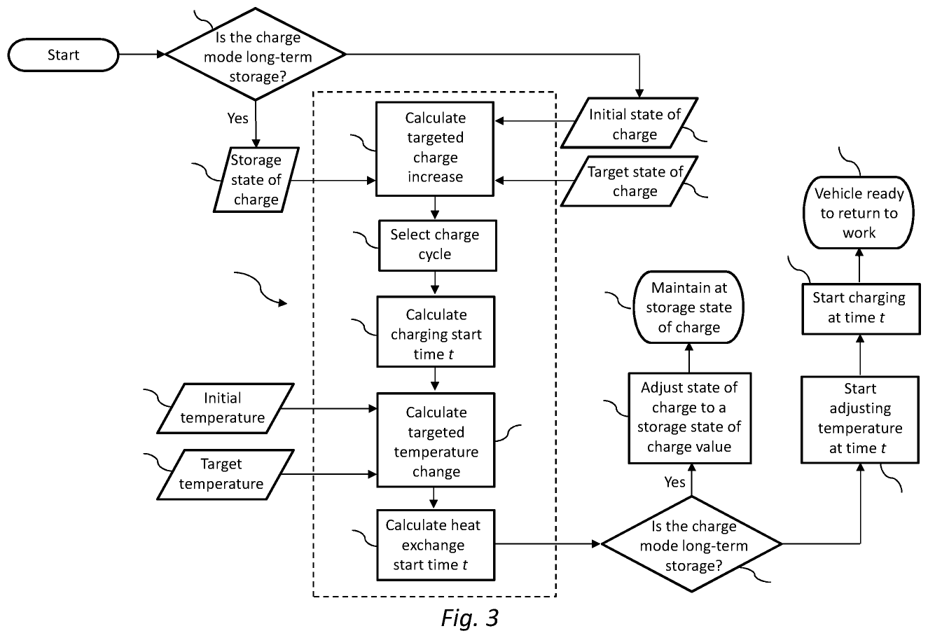

Referring to the embodiment shown in FIG. 3, there may be the additional provision to store the electric vehicle at a low state of charge in the event that the charge mode 121 selected is a long-term storage mode. Storing a battery at a low state of charge may be preferable for long-term battery health, however it may entail an extra charge cycle of charging or discharging to a storage state of charge and then recharging it which may be detrimental to long term battery health. There may therefore be a minimum length of storage time for which the benefits of storing at a low state of charge outweigh the adverse effects of the extra charge cycle. In an embodiment, the battery is stored at a low state of charge only if the charge mode 121 selected is long-term storage. In the event that the charge mode 121 selected is not a long-term storage mode at step 310, the process of charging is similar to that shown in FIG. 1 or FIG. 2 (reference numerals are the same for steps which are the same as FIG. 1). The initial state of charge value of the battery may be used to calculate the targeted charge increase and the battery may or may not be charged or discharged until the charging start time t_{C}. In the event that the charge mode 121 selected is a long-term storage mode at step 310, a storage state of charge value 311 may be used to calculate the targeted charge increase at step 110. After the charge cycle has been selected and the parameters calculated, the battery may be discharged (or charged) to the storage state of charge value at step 330 and is held there. At step 340, the state of charge value of the battery may be maintained at the storage state of charge value until the charging device is instructed to do otherwise. In a certain embodiment the storage state of charge value may be between 40% and 50% of full capacity.

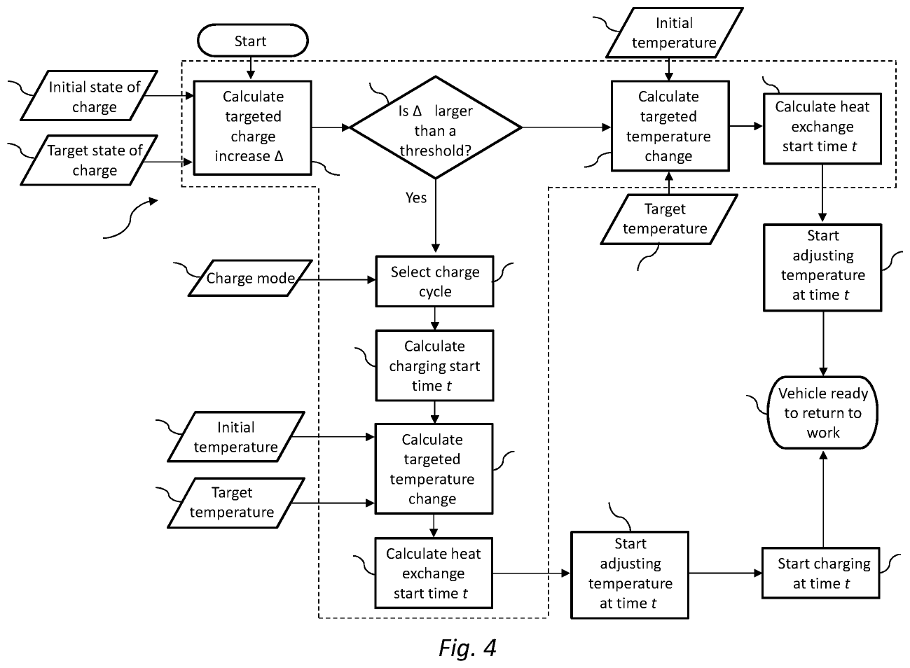

With reference to FIG. 4, there may be an option to not charge the battery if the initial state of charge value is close to the target state of charge. The calculated targeted charge increase may be compared to a charge threshold at step 410. If the targeted charge increase is lower than the charge threshold then charging does not take place. The battery or hydraulic fluid may be heated before the return to work time. The initial temperature 441 and target temperature 442 of the battery may be used to calculate the targeted temperature increase of the battery at step 440. The heat exchange start time t_{T} may then be calculated at step 450, and the temperature may be adjusted at the heat exchange start time t_{T} (step 460) such that the battery is at the target temperature at or before the return to work time. In the event that the targeted charge increase is higher than the charge threshold then the charging process may be carried out in a similar way to that shown in FIG. 1. Where the steps are the same as those in FIG. 1, the same reference numerals are used.

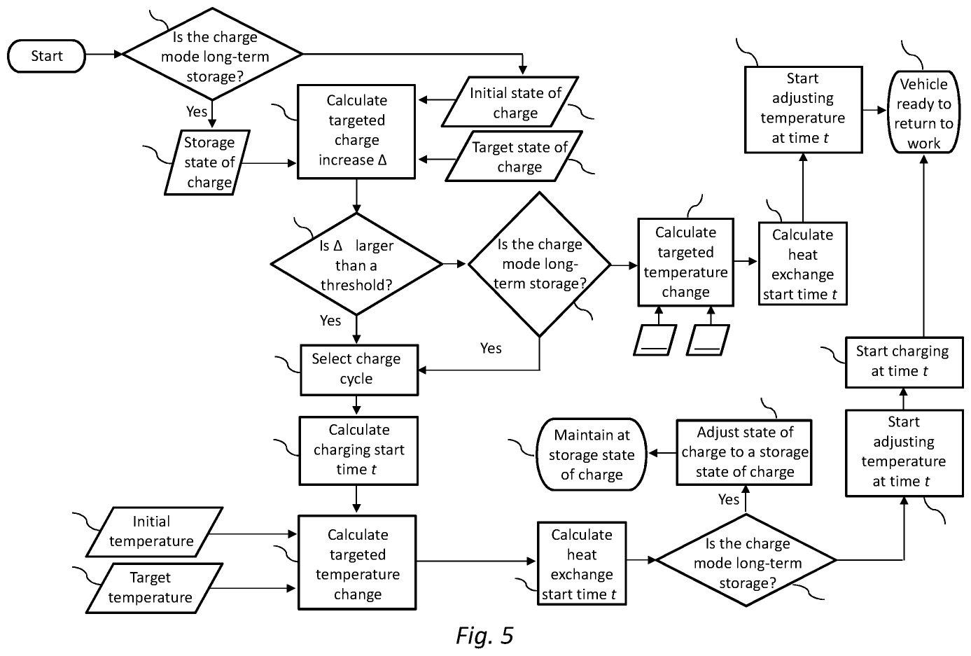

The processes shown in FIG. 3 and FIG. 4 may be combined, such that if the targeted charge increase is lower than the charge threshold but the expected duration of immobilization is longer than the storage threshold, the battery may be discharged to the storage state of charge value and the process continues in line with FIG. 3. This process is shown in FIG. 5. In the event that the charge mode 121 selected is long-term storage, the storage state of charge value 311 may be used to calculate the targeted charge increase at step 110. In the event that the charge mode 121 selected is not long-term storage, the initial state of charge value 111 of the battery is used to calculate the targeted charge increase at step 110. The targeted charge increase may then be compared of the charge threshold at step 410.

In the event that the targeted charge increase is larger than the charge threshold, the process may proceed similarly to FIG. 3. Reference numerals are the same for steps which are the same as FIG. 3. The charge cycle may be selected at step 120, and the charging start time may be calculated at step 130. The targeted temperature change may be calculated at step 140, and the heat exchange start time may be calculated at step 150. In the event that the charge mode is not a long-term storage mode at step 320, the next step 160 may be to heat or cool the battery to the target temperature 142 at the heat exchange start time t_{T}. At the charging start time t_{C} the battery may be at the target temperature 142 and charging begins at the charge rate until the state of charge value is equal to the target state of charge 112. The vehicle may then be ready to return to work at the return to work time, at step 180. In the event that the charge mode 121 selected is long-term storage at step 320, at step 330 the actual state of charge of the battery may be adjusted to be equal to the storage state of charge 311. The battery may be maintained at the storage state of charge at step 340, until the charging device receives further instructions.

In the event that at step 410 the targeted charge increase is smaller than the charge threshold, and in the event that the charge mode 121 selected is long-term storage at step 520, the battery may be stored with a state of charge equal to the storage state of charge so the process continues in the same way as if the targeted charge increase was found to be larger than the charge threshold at step 410, by selecting a charge cycle at step 120. In the event that the charge mode 121 selected is not long-term storage at step 520, it may be that no discharging or charging takes place and only the temperature is adjusted. The targeted temperature change may be calculated at step 540 using an initial temperature 541 and a target temperature 542, and the heat exchange start time t_{T} may be calculated at step 550. At the heat exchange start time t_{T} the temperature may be adjusted (step 560) and the vehicle is ready to return to work at the return to work time (step 180).

In certain embodiments, the processes shown in FIGS. 1 to 5 may be combined in various combinations.

In an embodiment of the disclosure the battery temperature may be obtained by measuring the temperature of the battery fluid. The heat exchange process may heat or cool the battery fluid using a liquid heat exchanger.

1. A method for managing state of charge of a battery of an electric work vehicle to be ready to return to work at a return to work time that coincides with an end of a duration of immobilization, comprising:
a. selecting a charge mode via an input of a user interface and obtaining data from an output of the user interface indicative of a charge mode;
b. using an initial state of charge value of the battery and a target operational state of charge value of the battery to calculate a targeted charge increase;
c. selecting a charge cycle based on the charge mode and the targeted charge increase, wherein the charge cycle comprises a charge rate;
d. calculating a charging start time based on the charge rate and the targeted charge increase, such that at the return to work time an actual state of charge of the battery corresponds to the target operational state of charge value;
e. using an initial temperature of the battery and a target temperature of the battery to calculate a targeted temperature change;
f. using the targeted temperature change to calculate a heat exchange start time such that the battery is at the target temperature before the charging start time;
g. adjusting the temperature of the battery at the heat exchange start time such that the battery is at the target temperature at the charging start time; and
h. starting the charge cycle at the charging start time such that the battery is at the target operational state of charge at the return to work time.

2. The method of claim 1 wherein the electric work vehicle comprises a hydraulic circuit for effecting movement of a machine work tool and wherein the method further comprises warming hydraulic fluid in the hydraulic circuit such that the hydraulic fluid is at a target hydraulic fluid temperature at the return to work time.

3. The method of claim 1 wherein in the event that the charge mode selected is a long-term storage mode, the method further comprises using a storage state of charge value as the initial state of charge at step (b).

4. The method of claim 3 wherein the method further comprises adjusting the state of charge of the battery to the storage state of charge value after step (f).

5. The method of claim 1 wherein the storage state of charge value is between 40% and 50%.

6. The method of claim 1 further comprising comparing the targeted charge increase to a charge threshold, wherein in an event that the targeted charge increase is smaller than the charge threshold the targeted charge increase is zero.

7. The method of claim 1 wherein the method further comprises performing a service process before the return to work time.

8. The method of claim 1 wherein the method further comprises obtaining data indicative of battery health.

9. The method of claim 1 wherein the charging start time may be further based on external factors which vary over the expected duration of immobilization, wherein the external factors comprise one or more of:
a. cost of electricity; and
b. temperature of the environment.

10. A battery charging controller for managing state of charge of a battery of an electric work vehicle to be ready to return to work at a return to work time that coincides with an end of a duration of immobilization, the battery charging controller configured to:
a. receive first data comprising an initial state of charge value of the battery;
b. receive second data from a user interface, wherein the second data is indicative of a charge mode;
c. receive third data comprising an initial temperature of the battery;
d. use the first data and a target operational state of charge of the battery to calculate a targeted charge increase;
e. select a charge cycle based on the second data and the targeted charge increase, wherein the charge cycle comprises a charge rate;
f. calculate a charging start time based on the charge rate and the targeted charge increase, such that at the return to work time an actual state of charge of the battery is the target operational state of charge value;
g. use the third data and a target temperature of the battery to calculate a targeted temperature change;
h. use the targeted temperature change to calculate a heat exchange start time such that the battery is at the target temperature before the charging start time;
i. adjust the temperature of the battery at the heat exchange start time such that the battery is at the target temperature at the charging start time; and
j. start the charge cycle at the charging start time such that the battery is at the target operational state of charge at the return to work time.

11. The battery charging controller of claim 10 wherein the electric work vehicle comprises a hydraulic circuit for effecting movement of a machine work tool and wherein the controller is further configured to warm hydraulic fluid in the hydraulic circuit such that the hydraulic fluid is at a target hydraulic fluid temperature at the return to work time.

12. The battery charging controller of claim 10 further configured to receive fourth data, wherein the fourth data comprises a storage state of charge value and wherein in the event that the charge mode selected is a long-term storage mode the battery charging controller is further configured to use the storage state of charge value as the first data comprising an initial state of charge value.

13. The battery charging controller of claim 16 wherein the controller is further configured to adjust the state of charge of the battery to the storage state of charge value after step (h).

14. The battery charging controller of claim 1 wherein the storage state of charge value is between 40% and 50%.

15. The battery charging controller of claim 1 wherein the controller is further configured to compare the targeted charge increase to a charge threshold, and in an event that the targeted charge increase is smaller than the charge threshold the targeted charge increase is zero.
